(19) United States
(12) Patent Application Publication
(10) Pub. No.: US 2002/0139447 A1
(43) Pub. Date: Oct. 3, 2002

(54) Magnetically anisotropic sintered magnets

(76) Inventors: Satoshi Hirosawa, Nagaokakyo-shi (JP); Kohki Tokuhara, Takatsuki-shi (JP); Ken Makita, Kyoto-shi (JP); Hiroshi Nagata, Mukoh-shi (JP)

Correspondence Address: DYKEMA GOSSETT PLLC, Franklin Square, Third Floor, 1300 I Street, N.W., Washington, DC, 20005-3306, US

(21) Appl. No.: 10/087,931

(22) Filed: Mar. 5, 2002

Related U.S. Application Data
(63) Continuation of application No. 09/829,967, filed on Apr. 11, 2001.
Application No. 09/829,967 is a continuation of application No. 08/837,329, filed on Apr. 11, 1997, now abandoned.
Application No. 08/837,329 is a continuation of application No. 08/695,774, filed on Aug. 8, 1996, now abandoned.
Application No. 08/695,774 is a continuation of application No. 08/554,030, filed on Nov. 6, 1995, now abandoned.
Application No. 08/554,030 is a continuation of application No. 08/394,219, filed on Feb. 24, 1995, now abandoned.
Application No. 08/394,219 is a continuation of application No. 08/236,159, filed on May 2, 1994, now abandoned.
Application No. 08/236,159 is a continuation of application No. 08/073,287, filed on Jun. 7, 1993, now abandoned.
Application No. 08/073,287 is a continuation of application No. 07/925,297, filed on Aug. 6, 1992, now abandoned.
Application No. 07/925,297 is a continuation of application No. 07/704,842, filed on May 20, 1991, now abandoned.
Application No. 07/704,842 is a continuation of application No. 07/525,319, filed on May 21, 1990, now abandoned.
Application No. 07/525,319 is a continuation of application No. 07/204,553, filed on Apr. 12, 1988, now abandoned.

(30) Foreign Application Priority Data
Feb. 29, 1988 (JP) 48127/63

(51) Int. Cl. H01F 1/04

(52) U.S. Cl. 148/302; 148/303

(57) ABSTRACT

In this invention, enhancement of the coercive force of the Fe-B-R based magnetic anisotropic sintered magnets was studied by increasing a content of B and, in addition, containing into material a small amount of such as Al, Si, Cu, Cr, Ni, and Mn effective of enhancing the coercive force and excluding from the material harmful impurities such as P, S, and Sb. This material was powdered by usual melting, casting, crushing, or direct reduction method. This powder was subjected to orientation in a magnetic field, compacted, sintered and subjected to heat treatment. Thus the Fe-B-R based sintered permanent magnets were obtained that have the maximum energy product more than 20MGOe and the coercive force more than 15kOe.

### TECHNICAL FIELD

This invention relates to Fe-B-R based magnetically anisotropic magnets that are not demagnetized when they are mounted on electric motors for vehicles and used in high temperature environment. The invention provides the magnetically anisotopic magnets that do not necessarily, require expensive heavy rare earth elements and can keep the high maximum energy product and develop the high coercive force. The invention also provides said magnets with low cost.

### BACKGROUND ART

The permanent magnet materials are one of very important materials applied to electric and electronic goods and they are used in a very wide area--covering various types of home electric appliances, parts for automobiles and communication equipments and peripherals for large scale computers. Recently, with the need for high performance and miniaturization of the electric and electronic equipments, the high performance of the permanent magnets are required. Traditionally, the rare earth cobalt magnet is well known to comply with these needs. However, the rare earth cobalt magnet needs a large amount of expensive samarium as the rare earth which is not abundantly contained in the rare earth ore and also needs cobalt by 50-60 weight %.

The applicant of this invention has discovered formerly a ternary compound which does not necessarily contain rare and expensive samarium or cobalt but does contain light rare earth elements such as neodymium or praseodymium abundant in rare earth ore as the main elements and contains iron, boron and the rare earths R as the essential elements and thus has excellent magnetic properties with uni-axial magnetic anisotropy by combining the rare earths with iron an boron. Then the applicant has proposed the Fe-B-R based magnetically anisotropic magnets which develop high permanent magnet properties that far exceed the maximum energy product or the conventional rare earth cobalt magnets. (EPC. Publication No. 83 106 573.5).

Permanent magnets have increasingly been exposed to severe environment such as increase of self-demagnetizing field due to thinning of magnets, strong demagnetizing field applied from coils and other magnets, and exposition to high temperature environment due to tendency to higher speed and heavier load for equipments and appliances.

It is well known that the Fe-B-R based magnetically anisotopic sintered magnets show almost constant temperature coefficient of coercive force (iHc), about minus 0.6 percent per a degree centigrade regardless of some modifications of compositions or manufacturing methods when Nd or Pr are selected as a rare earth element.

Therefore, it is necessary for the magnets to have higher coercive force to be used in the severe environment as mentioned above.

The applicant has further proposed that the Fe-B-R based permanent magnets using heavy rare earth elements Dy, Tb as part of R complies with this higher coercive force requirement. (EPC. Publication No. 83 109 501.3).

But these heavy rare earth elements Dy, Tb are very rare in their ore and also expensive.

As the methods of increasing the coercive force without using these expensive heavy rare earth, following methods were disclosed in which additive elements M such as V, Cr, Mn, Ni, Mo, Zn and so on are added, or an amount of rare earth Nd, Pr or boron is increased. (EPC. Publication No. 83 106 573.5) The method of using the additive elements M has surely a distinctive effect on increase in the coercive force by adding M of 1-2 atom %, while more additive M provides little effect on increase in the coercive force when its enhancement is required, and most of M cause a reduction of saturation magnetization and forms non-magnetic boride compounds with boron and this brings rapid decrease in the maximum energy product.

Also, increase in an amount of rare earth or boron as well as more additive M has been considered to bring gradual increase of coercive force and rapid decrease in energy product. (EPC. Publication No. 83 106 573.5, refer to FIGS. 3 and 4)

In view of these situations at present, the object of this invention is to provide the Fe-B-R based magnetically anisotropic sintered magnets which do not necessarily need expensive heavy rare earth elements and do not cause rapid decrease in maximum energy product due to increase in coercive force, keeping more than 20MGOe and having high coercive force more than 15kOe.

### DISCLOSURE OF THE INVENTION

In this invention, compositions of the Fe-B-R based magnetically anisotropic sintered magnets were considered to improve the coercive force by increasing an amount of B, and as the result of these considerations, it was found that an amount as small as impurity level contained in industrial raw materials give rise to increase in coercive force and said sintered magnets having very large coercive force without reducing the maximum energy product are obtained by controlling the amount of these elements represented below.

That is, the fact described below was found that containing into material a small amount of solutes such as Al, Si, Cu, Cr, Ni, and Mn effective for enhancing the coercive force and excluding from the material harmful impurities such as P, S, and Sb, and then this material was powdered by usual melting, casting, crushing, or direct reduction method and this powder was subjected to orientation, in a magnetic field compacted, sintered and optionally subjected to heat treatment and thus the Fe-B-R based sintered magnets were obtained that have the maximum energy product more than 20MGOe and the coercive force more than 15kOe.

The present invention provides a magnetically anisotropic sintered magnet consisting essentially of, by atomic percent, 14-18% R wherein R is Nd and/or Pr, 9-18% of B, 0.5-5% A wherein A is the total of 0.2-2.0% Al, 0.01-0.5% Si and 0.03-0.6% Cu and a leas one of 0.02-3.0% Cr, 0.05-1.0% Mn and 0.02-1.0% Ni and the balance being Fe.

The present invention also provides magnetically anisotropic sintered magnet consisting essentially of, by atomic percent, 14-18% R wherein R is Nd and/or Pr, 9-18% B, 0.5-5% A wherein A is the total of 0.2-2.0% Al, 0.01-0.05% Si and 0.03-0.6% Cu and at least one of 0.02-3.0% Cr, 0.05-1.0% Mn and 0.02-1.0% Ni, less than 2.0% of a total amount of less than 2.0% of at least one selected from V, Mo, Nb and W and less than 1.0% at least one selected from of Zn, Ti, Zr, Hf, Ta, Ge, Sn, B, Ca, Mg and the balance being Fe.

The present invention also provides a magnetically anisotropic sintered magnet consisting essentially of, by atomic percent, 14-18% R wherein R is less than 2.5% of Dy and/or Tb of the magnet and the balance of R being Nd and/or Pr. 9-18% B, 0.5-5% A wherein A is the total of 0.2-2.0% Al, 0.01-0.5% Si and 0.03-0.6% Cu and at least one of 0.02-3.0% Cr, 0.05-1.0% Mn and 0.02-1.0% Ni and the balance being Fe.

The present invention also provides a magnetically anisotropic sintered magnet consisting essentially of, by atomic percent, 14-18% R wherein R is Nd and/or Pr, 9-18% B, 0.5-5% A wherein A is the total of 0.2-2.0% Al, 0.01-0.5% Si and 0.03-0.6(% Cu and at least one of 0.02-3.0% Cr, 0.05-1.0% Mn and 0.02-1.0%7 Ni less than 10% Co and the balance being Fe.

The present invention also provides a magnetically anisotropic sintered magnet consisting essentially of, by atomic percent, 14-18% R wherein R is less than 2.5% of Dy and/or Tb as a part of R and the balance of R being Nd and/or Pr, 9-18% B, 0.5-5% A wherein A is the total of Al, Si and Cu and at least one of Cr, Mn and Ni and provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

less than 2.0% of a total amount of less than 2.0% of at least one selected from V, Mo, Nb and W and less than 1.0% at least one selected from of Zn, Ti, Zr, Hf, Ta, Ge, Sn, Bi, Ca, Mg less than 10% Co and the balance being Fe.

### DETAILED DESCRIPTION OF PREFERRED EMBODIMENTS OF THE INVENTION

In this invention, the rare earth R are Nd and Pr, and one of them is usually used to satisfy requirement but a mixture of them may be used to comply with circumstance of material procurement.

If a content of R is less than 14 at %, a large coercive force more than 15kOe, that is the characteristic of this invention, is not obtained and if the content exceeds 18 at %, the residual magnetic flux density (Br) decreases and a value more than (BH)max 20MGOe is not obtained, therefore the content is maintained within the range of 14 at %-18 at %.

The R content within the range of 15 at %-17 at % permits the magnets to obtain coercive forces more than 18kOe without decreasing (BH)max, and therefore this range is preferable.

In this invention, more than 9 at % adding of B is required to obtain the maximum energy product above 20MGOe and the coercive force above 15kOe, however more than 18 at % adding decreases the residual magnetic flux density, therefore the adding should be limited within the range of 9 at %-18 at %.

Further, the B within the range of 10 at %-17 at % permits the magnets to obtain coercive forces more than 18kOe without addition of heavey rare earths elements, then this range is especially preferable.

It is known that the Fe-B-R based sintered magnetic have a tetragonal crystal structure and compounds indicated by a formula R₂F₁₄B determine magnetic properties. The compounds exist in a sintered body as crystal grains having mean particle diameters of 1-20 μm. Both R-rich phase which is almost occupied by rare earth and B-rich phase indicated by R_{1.1}Fe₄B₄ take great parts in mechanism of coercive force.

It is supposed that the reason why a very small amount of additive elements A characterized in this invention has great effect on coercive force enhancement is because the additives effectively act on circumferences of the tetragonal crystal particles, that support the magnetic performance of the sintered magnet within the range of several atomic layers.

In this invention, a very small amount adding of the essential elements Al, Si and Cu among the additives develops distinctive enhancement of coercive force. In order to obtain such an effect, at least adding of Al more than 0.2 at % content, Si more than 0.01 at % content, and Cu more than 0.03 at % content is required.

Further, for the purpose of obtaining the maximum energy product more than 20MGOe nd the coercive force more than 15kOe, adding of Al less than 2.0 at % content and Si less than 0.5 at % content is required. If the Cu content exceeds 0.6 at %, the coercive force on the contrary decreases, thus the content should be limited to less the 0.6 at %.

In addition, containing at least one of Cr, Mn and Ni, and a very small amount adding of Cr more than 0.02 at %, Mn more than 0.05 at % an Ni more than 0.02 at % have a good effect on the coercive force enhancement.

However, a relatively large amount adding of Cr, Mn and Ni causes degradation of magnetic properties of elevated temperatures through considerable decrease in Curie temperature or causes on the contrary coercive force decrease, thus adding of Cr less than 3.0 at % and Mn less than 1.0 at % should be required. If Ni content exceeds 1.0 at %, coercive force decreases, then the content is required to be less than 1.0 at %.

When a total amount of adding of the additive elements A, namely, Al, Si, Cu, Cr, Mn and Ni is less than 0.5 at %, this has no good effect on coercive force enhancement. The total amount of adding exceeding 5.0 at % causes the decrease of the maximum energy product, thus the range of 0.5 at %-5.0 at % should be observed.

Further, in this invention, at least one of V, Mo, Nb and W and at least one of Zn, Ti, Zr, Hf, Ta, Ge, Sn, Bi, Ca, Mg and Ga may be added to enhance coercive force and ever only a little adding of 0.1 at % can enhance coercive force.

However, if the magnet contains at lest one of V, Mo, Nb an W each having a content more than 2.0 at %, or at least one of Zn, Ti, Zr, Hf, Ta, Ge, Sn, Bi, Ca,, Mg and Ga each having content more than 1.0 at %, and further if a total amount of selected elements exceeds 2.0 at % content, these causes decrease of the maximum energy product and are not preferable.

Co raises the Curie temperature of the Fe-B-R based permanent magnets and improves the temperature characteristic of the residual magnetic flux density and anti-corrosive. To obtain these effects, adding of Co more than 0.1 at % of the magnet content is required. However a relatively large amount adding yields RCo intermetallic compounds that decrease coercive force, thus adding contents less than 10 at % are preferable.

When at least one of Mn, Cr and Ni are added so that a total content is more than 0.5 at %, this produces an advantage that oxidation of the fine powder material during processing can be reduced.

When Cr is added to produce a content more than 1.0 at %, anti-corrosive of the alloy powder and the finished products can be remarkably improved.

When the permanent magnets of this invention are manufactured, sometimes they contain O₂ or C. That is, the magnets contain them at each process such as raw material, melting, crushing sintering and heat treatment. The content less than 8000 ppm does not damage the effect of this invention but the content less the 6000 ppm is preferable.

Sometimes C may be contained in materials or it is added as binder or lubricant of improve moldability of the compact after pressing. The contentless than 3000 ppm during sintering does not damage the effect of this invention but the content less than 1500 ppm is preferable.

This invention allows the magnets to obtain large coercive forces not necessarily requiring the heavy rare earth as R and permits further improvement of coercive force enhancement by replacing said Nd, Pr with a small amount of Dy, Tb if necessary.

If the amount of replacement by Dy, Tb is more than 0.05 at %. the effect of the coercive force enhancement is obtained an even a small amount of additives yields the equivalent or more effect than that obtained from said conventional positive adding of Dy, Tb, therefore the upper limit of this positive adding of Dy, Tb, therefore the upper limit of this adding should be limited to 2.5 at % of the magnet.

The concentration range large than 0.5 at % is the preferable as the concentration of Dy and Tb, because it provides iHc larger than 20kOe maintaining 20MGOe.

Method of Making

Alloy powder having Fe-B-R compositions is firs obtained as start material.

After the material is alloy-melted in an usual manner, an alloy ingot is obtained from, for example, casting cooled in the condition that does not cause amorphous state, then this alloy ingot is crushed, classified an mixed to produce alloy powder, or alloy powder obtained from rare earth oxides by reduction by Ca or Mg may be used (direct reduction methed).

Mean particle size should be within the range of 0.5-10 μm.

Mean particle size of 1.0-5 μm is the most preferable to obtain excellent magnetic properties.

Crushing may be implemented both in the wet crushing that is performed in a solvent or in the dry crushing that is performed in a gas atmosphere such as N₂ and the jet mill in the dry crushing that yields uniform powder particle size is recommended to obtain a higher coercive force.

Then the alloy powder is compacted and this compact may be carried out in the same manner as the usual powder metallurgy. The pressurized molding is preferable and alloy powder, for example, is pressed and compacted at a pressure of 0.5-3.0 ton/cm² in a magnetic field the intensity of which is more than 5 kOe to acquire anisotropy.

Sintering of the compacted body is carried out in a deoxidizing or non-oxidizing atmosphere at a predetermined temperature within the range of 900-1200° C. This is recommendable.

For example, the compacted body is sintered at a temperature within the range of 900-1200° C. for 0.5-4 hours in a vacuum less than 10⁻² Torr, or in an inert gas or a deoxidizing gas atmosphere with 1-76 Torr and gas purity more than 99%.

The sintering is performed adjusting the conditions of temperature and time in order to acquire a predetermined crystal particle diameter and density in the sintered body.

The density of the sintered body is preferably more than 95% of the theoretical density (ratio), for example, a density more than 7.2 g/cm³ is acquired at a sintering temperature within the range of 1040-1160° C., and this corresponds to more than 95% of the theoretical density. Furthermore, more than 99% theoretical density ratio is obtained within the range of 1060-1100° C. and this is especially preferable.

Heat treatment of the sintered body at a temperature within the range of 400-900° C. for 0.1-10 hours is effective to further improve coercive force. In these heat treatment temperature condition, the sintered body may be maintained at a required constant temperature or my be gradually cooled or subjected to multi-stage heat-treating within a predetermined temperature range.

It is preferable that the heat treatment is implemented in a vacuum, or in an inert gas or deoxidizing gas atmosphere.

The heat treatment for the Fe-B-R based sintered magnets is effectively performed in the condition that after sintering the body is once maintained at a temperature within the range of 650-900° C. for 5 minutes-10 hours and subjected to multi-stage, heat treatment, two stages or more which is implemented at a lower temperature than that of one-stage aging.

### BRIEF DESCRIPTION OF DRAWINGS

FIG. 1 shows the relationship between boron concentration an coercive force iHc. FIG. 2 shows the relationship between boron concentration and maximum energy product (BH)max.

### EXAMPLE

### Example 1

Ingots having 15NdxB(100−x)Fe in at % (x=4˜25) compositions were manufactured by melting, using:

fineness 97 wt % Nd (the remainder is almost rare earth elements such as Pr),

electrolytic iron (Si, Mn, Cu, Al and Cr each having wt % less than 0.005 wt %)

and as B

\mathring{1} commercially available ferroboron (equivalent to JIS G2318 FBL1; 19.4 wt % B, 3.2 wt % Al, 0.74 wt5 Si, 003 wt % C, the remainder is composed of other impurities and Fe.)

\mathring{2} commercially available high fineness boron of fineness 95% or larger containing little impurities.

Further, as \mathring{3} the embodiment of this invention, ingots containing 0.4 at % Al-0.3 at % Si-0.15 at % Cu-0.08 at % Mn-0.5 at % Cr-0.3 at % Ni were similarly manufactured by substituting for Fe in said \mathring{2}.

These ingots were roughly crushed by a jaw crusher and finely pulvelized in and N₂ gas atmosphere by a jet mill and fine particle powder having mean particle size of 3.3-3.6 μm was finally obtained.

This material powder was compacted with pressure of 1.5 ton/cm² in a magnetic field applied perpendicular to the press directions the intensity of which was 10kOe. The compacted body thus obtained was subjected to sintering at a temperature within the range of 1040-1100° C. and the sintered body having the theoretical density ratio more than 96% was obtained.

Further, these sintered bodies were heat-treated by 25° C. steps for 2 hours within the range of 900-400° C. The specimens having the best magnetic properties were picked up and their magnetic properties were measured at room temperature(22° C.) and compared one another on the properties variations vs boron amounts added.

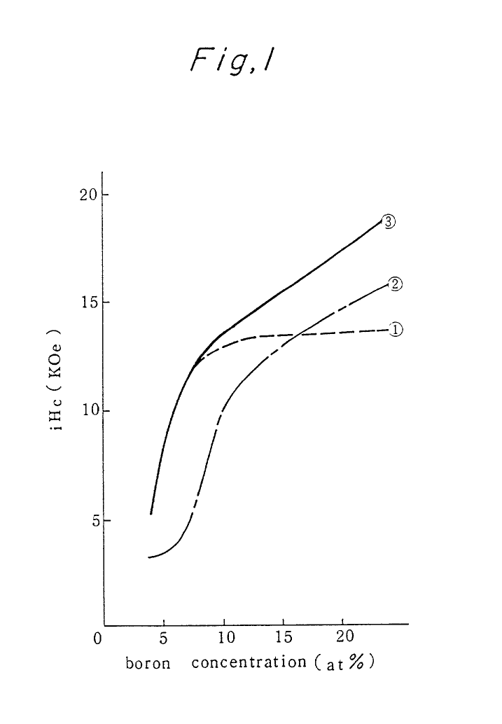

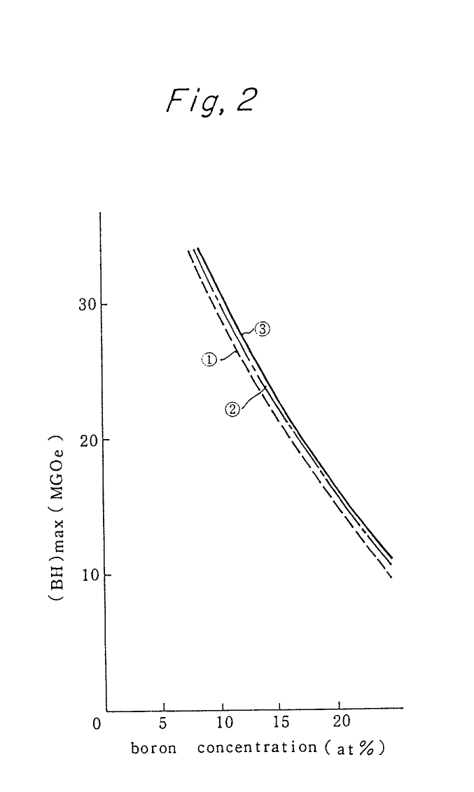

Variations of coercive force are shown in FIG. 1 and variations of the maximum energy product are shown in FIG. 2. The curves of the maximum energy product derived from each material \mathring{1}, \mathring{2}and \mathring{3}show almost no difference, however the curve \mathring{1} of the coercive force derived from the material \mathring{1}, namely, the commercially available ferroboron whose impurities are not controlled shows no effect of increasing coercive force at the point of about 10 at % boron concentration and thereafter.

Further, the curves show if the high fineness boron is used that does not contain the very small amount elements used in this invention, a considerable amount of boron must be used as compared with the embodiments of this invention to acquire a predetermined coercive force.

On the contrary, the sintered magnet according to the invention has an energy product more than 20MGOe and keeping this condition, a large coercive force is obtained as shown in FIGS. 1 and 2.

### Example 2

Similarly to Example 1, ingots having 16Nd9B remainder Fe based compositions in at % in which additives from the following set 0.5Al-0.18Si-0.12Cu-0.3Mn-0.5Cr-0.5Ni (total 2.1 at %) were made by substituting for Fe. The effect of the elements on the magnetic properties was studied. Measurements of the coercive force are shown in Table 1.

As can be seen from Table 1, the effect of Al, Si and Cu is remarkable and if any one of these elements lacks, the coercive force decreases.

Concerning Mn, Cr and Ni, existence of any one of these can keep the coercive force from decreasing. Lack of these elements decrease the coercive force.

TABLE 1

| No. | Al | Si | Cu | Mn | Cr | Ni | iHc kOe |
|---|---|---|---|---|---|---|---|
| 1 | ◯ | ◯ | ◯ | ◯ | ◯ | X | 16.7 |
| 2 | ◯ | ◯ | ◯ | ◯ | X | ◯ | 16.1 |
| 3 | ◯ | ◯ | ◯ | X | ◯ | ◯ | 16.5 |
| 4 | ◯ | ◯ | ◯ | X | ◯ | X | 16.4 |
| 5 | ◯ | ◯ | ◯ | ◯ | ◯ | ◯ | 16.8 |
| *6 | ◯ | ◯ | X | ◯ | ◯ | ◯ | 14.3 |
| *7 | ◯ | X | ◯ | ◯ | ◯ | ◯ | 14.7 |
| *8 | X | ◯ | ◯ | ◯ | ◯ | ◯ | 13.8 |
| *9 | ◯ | ◯ | ◯ | X | X | X | 14.0 |
| *10 | X | X | X | X | X | X | 12.6 |

Mark ◯ stands for adding, mark X no adding
*; Comparative example

### Example 3

Similarly to Example 1, the magnets having 0.5 at % Al -0.15 at % Cu-0.18 at % Mn-0.3 at % Si -0.5 at % Cr (=A, total 1.63 at %) of very small amount elements were manufactured. Measurements of the magnetic properties are shown in Table 2.

TABLE 2

| | | Br | (BH)mzx | iHc |
|---|---|---|---|---|
| No. | Composition | kOe | MGOe | kOe |
| 11 | 17Nd-9B-Fe-A | 11. | 32.2 | 18.7 |
| 12 | 17Nd-17B-Fe-A | 9.1 | 20.0 | 20.6 |
| 13 | 16Nd-1Dy-14B-Fe-A | 9.4 | 22.1 | 22.1 |
| *14 | 15Nd-6Co-14B-65Fe | 9.7 | 23 | 11.8 |
| | (used pure boron) | | | |
| 15 | 15Nd-6Co-14B-65Fe-A | 9.7 | 23 | 15.2 |
| *16 | 15Nd-6Co-14B-65Fe | 9.7 | 23 | 13.8 |
| | (used ferro boron) | | | |
| 17 | 15Nd-17B-67.5Fe-0.5Nb-A | 9.3 | 21.5 | 17.0 |
| 18 | 15Nd-17B-67Fe-0.5Nb-0.5Zr-A | 9.2 | 20.5 | 17.5 |
| 19 | 15Nd-17B-67.5Fe-0.5V-A | 9.3 | 21.3 | 17.1 |

(*; Comparative example)

Industrial Applicability

The magnets according to this invention are pressed to a direction perpendicular to a magnetic field, sintered and subjected to heat treatment. By these processing the magnets can have the maximum energy product more than 20MGOe and the coercive force more than 15 kOe and develop stable magnetic properties than 150° C. Sintered magnets obtained by pressing in a magnetic field applied parallel to the press direction followed by sintering and optional heat treatment have a smaller energy products than the above said magnets, but are good enough to be used practically.

This sintered magnets according to the invention are characterized in that they have a high content of B and very small amount additive elements. Even though the B content is increased more than several at %, the weight of the magnet increases little, and the adding amount of the additive elements A is very small, therefore high coercive force magnets can be obtained without changing the conventional manufacturing method.

In addition, mechanical strength such as flexural strength does not vary regardless of increase of a boron concentration and the high mechanical strength can be obtained that is the characteristic of the Fe-B-R based magnets.

Further, the magnets according to the invention do not have worsening of the bending characteristic of the demagnetizing curve an have an excellent bending characteristic.

Still further, this invention is characterized in that the magnets do not necessarily need the heavy rare earth and has an advantage that if a large coercive force, for instance, larger than 20kOe is required, adding of a very small amount of Dy and Tb may satisfy the requirement.

As can be seen from the embodiments, the improvement of the coercive force can not be obtained from using only materials already containing Al or Si and commercially available ferroboron or boron containing a relatively large amount of impurities. The effect of this invention is not acquired until the materials are controlled to contain predetermined contents of additives according to the invention.

1. A magnetically anisotropic sintered magnet consisting essentially of, by atomic percent, 14-18% R wherein R is Nd and/or Pr, 9-18% B, 0.5-5% A wherein A is the total of Al, Si and Cu and at least one of Cr, Mn and Ni and provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

and the balance being Fe.

2. A magnetically anisotropic sintered magnet consisting essentially of, by atomic percent, 14-18% R wherein R is Nd and/or Pr, 9-18% B, 0.5-5% A wherein A is the total of Al, Si and Cu and at least one of Cr, Mn and Ni and provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

less than 2.0% of a total amount of less than 2.0% of at least one selected from V, Mo, Nb and W and less than 1.0% at least one selected from of Zn, Ti, Zr, Hf, Ta, Ge, Sn, Bi, Ca, Mg and the balance being Fe.

3. A magnetically anisotropic sintered magnet consisting essentially of, by atomic percent, 14-18% R wherein R is Nd and/or Pr, 9-18% B, 0.5-5% A
wherein A is the total of Al, Si and Cu and at least one of Cr, Mn and Ni an provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

less than 10% Co and the balance being Fe.

4. A magnetically anisotropic sintered magnet consisting essentially of, by atomic percent, 14-18% R
wherein R is less than 2.5% of Dy and/or Tb as a part of R and the
balance of R
being Nd and/or Pr,
9-18% B,
wherein A is the total of Al, Si and Cu and at least one of Cr, Mn and Ni and provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

and the balance being Fe.

5. A magnetically anisotropic sintered magnet consisting essentially of, by atomic percent, 14-18% R wherein R is less than 2.5% of Dy and/or Tb as a part of R and the balance of R being Nd and/or Pr, 9-18% B, 0.5-5% A wherein A is the total of Al, Si and Cu and at least one of Cr, Mn and Ni an provided that, the range of each element is

| | | | |
|---|---|---|---|
| Al | 0.2-2.0%, | Si | 0.01-0.5% |
| Cu | 0.03-0.6% | Cr | 0.02-3.0% |
| Mn | 0.05-1.0% | Ni | 0.02-1.0% |

less than 2.0% of a total amount of less than 2.0% of at least one selected from V, Mo, Nb and W and less than 1.0% at least one selected from of Zn, Ti, Zr, Hf, Ta, Ge, Sn, Bi, Ca, Mg less than 10% Co and the balance being Fe.
